(19) United States
(12) Patent Application Publication
(10) Pub. No.: US 2024/0308763 A1
(43) Pub. Date: Sep. 19, 2024

(54) Robotic Cargo Loading Gantry

(71) Applicant: Nimble Robotics, Inc., San Francisco, CA (US)

(72) Inventor: Simon Kalouche, San Francisco, CA (US)

(73) Assignee: Nimble Robotics, Inc., San Francisco, CA (US)

(21) Appl. No.: 18/681,357

(22) PCT Filed: Aug. 29, 2022
(86) PCT No.: PCT/US2022/041817

§ 371 Date: Feb. 5, 2024

Related U.S. Application Data
(60) Provisional application No. 63/238,481, filed on Aug. 30, 2021.

(51) Int. Cl. B65G 1/04; B65G 1/137

(52) U.S. Cl. CPC B65G 1/0464; B65G 1/1373

(57) ABSTRACT

A gantry for loading or unloading containers into a cargo area of a vehicle. The gantry includes a pair of substantially parallel beams extending in a first horizontal direction, a rail mounted between the beams to be moveable in the first horizontal direction, and a trolley coupled to and moveable along the rail in a second horizontal direction perpendicular to the first horizontal direction. The trolley supports a hoist including a plate having an actuatable gripping device for selectively engaging and releasing the containers, and the plate is moveable in a vertical direction relative to the trolley between a retracted position and an extended position to lift and lower the containers. The gantry is thus arranged to load/unload containers into the cargo area in horizontal levels.

### CROSS-REFERENCE TO RELATED APPLICATIONS

The present application claims the benefit of the filing date of U.S. Provisional Application No. 63/238,481, filed Aug. 30, 2021, the disclosure of which is hereby incorporated herein by reference.

### BACKGROUND OF THE INVENTION

The present disclosure relates generally to cargo loading devices, and more particularly, to gantries for loading containers into delivery vehicles and/or unloading containers from delivery vehicles.

Distribution fulfillment centers, such as warehouses, require systems that enable the efficient shipment of inventory. The inventory is typically packed into containers and then loaded into a delivery truck manually by loading dock personnel or with the help of one or more machines or robotic systems.

When the containers are manually loaded, the loading dock personnel walk the containers into the cargo area of a semi-trailer and place the containers adjacent the front wall of the semi-trailer (e.g., closest to the tractor-truck) in one or more stacks before other stacks of containers are placed toward the rear of the semi-trailer. This process is labor intensive (e.g., costly and likely to cause injury) and makes stacking the containers in orderly stacks difficult. Put another way, the stacks are subject to toppling over before adjacent stacks are loaded which may damage the products or cause injury to the loading dock personnel. It will be appreciated that the containers cannot be loaded in levels (which would assist in orderly stacking), when loaded manually, without requiring the loading dock personnel to step on or jump over earlier loaded containers.

Alternatively, the containers can be loaded into the semi-trailer with the assistance of one more machines, such as a forklift, configured to load pallets of items into the cargo area of the trailer. However, the pallets reduce the amount of space that can used for inventory. This wasted space increases operating costs.

Robotic and other automated systems have been proposed for loading and unloading cargo, but these systems also have a number of significant drawbacks. For example, these systems often require that their components be disposed within the semi-trailer during operation, which, may cause the semi-trailers to shake, or even tip, as the relatively heavy robotic equipment moves therein. This shaking can even cause the stacks of containers to shift and, in some instances, can dislodge a container from the stack. Consequently, assistance from loading dock personnel is often required to adjust the stacks during the loading process. Moreover, the automated robotic systems often occupy a significant amount of floor space making it difficult for loading dock personnel to work alongside the robot. As a result, the robotic equipment has to be removed from the cargo space in order to allow loading dock personnel to access the cargo area. This in turn slows down the loading or unloading process.

Additionally, the fact that the robotic systems consume a large volume of the cargo area during the loading/unloading process necessitates that the containers be loaded into the semi-trailer in vertical stacks, from the front end to the backend of the trailer, as opposed to in levels that span the trailer. For example, U.S. Pat. Pub. No. 2016/0068357 discloses a gantry equipped with a robotic arm having a length sufficient to handle containers located on the floor of the semi-trailer. The lengthy and non-compact robotic arm is incapable of “passing over” stacks of vertical containers to stack and/or readjust containers located in front of other stacked containers. As a result, the gantry of U.S. Pat. Pub. No. 2016/0068357 is required to load containers into the semi-trailer in the same fashion as loading dock personnel (e.g., in vertical stacks and from the front end to the backend of the trailer).

### BRIEF SUMMARY OF THE INVENTION

In accordance with a first aspect of the present disclosure, a gantry provided with an actuatable hoist that can selectively grab and release containers is provided. Among other advantages, the hoist assists in loading and unloading containers from a trailer in levels. In this regard, a stronger foundation of containers can be built to support adjacent stacks of containers which facilitates orderly stacking. Consequently, the trailer can be packed more densely and efficiently such that the containers are less susceptible to toppling during loading, transportation of the trailer, or unloading of the containers.

In one embodiment, a gantry includes a pair of substantially parallel beams extending in a first direction, a rail mounted between the beams to be moveable in the first direction, and a trolley coupled to and moveable along the rail in a second direction perpendicular to the first direction. The trolley supports a hoist including a plate having an actuatable gripping device for selectively engaging and releasing the containers, and the plate is moveable in a vertical direction relative to the trolley between a retracted position and an extended position to lift and lower the containers.

In another embodiment, a gantry includes a base including a cross-rail, a single beam mounted to a trolley moveable along the cross-beam in a first direction, and a hoist moveable along the single beam in a second direction transverse to the first direction. The hoist includes a plate having an actuatable gripping device for selectively engaging and releasing the containers, and the plate is moveable in a vertical direction between a retracted position and an extended position to lift and lower the containers.

In yet another embodiment, an automated gantry includes a base moveable in a first direction formed of a pair of support legs and a cross-rail extending between the pair of support legs, a trolley moveable along the cross-rail in a second horizontal direction perpendicular to the first horizontal direction, and a hoist coupled to the trolley. The hoist includes a plate having a gripping device for selectively engaging and releasing containers, and the plate is moveable in a vertical direction relative to the trolley between a retracted position and an extended position to lift and lower the containers.

In a further embodiment, an automated gantry includes first and second beams elevated above a ground surface and extending in a first horizontal direction, a rail extending between first and second carriages movably mounted to the first and second beams, respectively, such that the rail is moveable along the first and second beams in the first horizontal direction, a trolley coupled to and moveable along the rail in a second horizontal direction perpendicular to the first horizontal direction, and at least one hoist coupled to the trolley. The at least one hoist includes a plate having an actuatable gripping device for selectively engaging and releasing the containers, and the plate is moveable in a vertical direction relative to the trolley between a retracted position and an extended position to lift and lower the containers.

### BRIEF DESCRIPTION OF THE DRAWINGS

FIG. 1 is a perspective view of a gantry equipped with a hoist in accordance with an embodiment of the present disclosure.

FIG. 2 is a perspective view of the hoist of FIG. 1.

FIG. 3 illustrates an example process of loading containers into a delivery vehicle using the gantry of FIG. 1.

FIG. 4 is a perspective view of a gantry equipped with a hoist in accordance with another embodiment of the present disclosure.

FIG. 5 is a partial perspective view of a gantry equipped with a hoist in accordance with yet another embodiment of the present disclosure.

FIGS. 6A and 6B are perspective and top elevation views, respectively, of example hoists for use with the gantry of FIG. 5.

FIGS. 7A and 7B are top elevation views of additional example hoists for use with the gantry of FIG. 5.

FIG. 8 is a perspective view of a gantry equipped with a hoist in accordance with a further embodiment of the present disclosure.

### DETAILED DESCRIPTION

The technology disclosed herein relates to a gantry equipped with an extendable and retractable hoist. The hoist may be used, for example, to load containers into the cargo area of a delivery vehicle and/or unload containers from the cargo area of the delivery vehicle without the gantry placing a force on the floor of the cargo area. Moreover, when the hoist is retracted, the hoist has a small vertical footprint allowing the hoist to pass over previously loaded containers. As a result, the containers can be loaded in sequential levels (e.g., horizontal rows that the span the trailer before another level is loaded on top of the earlier loaded level) as opposed to in vertical stacks (e.g., containers stacked directly on top of one another requiring that the vertical stacks be loaded from the front end to the backend of the semi-trailer). When the containers are loaded in levels, a stronger foundation is built for the subsequently loaded containers which improves the stability of the stacks and the density to which the semi-trailer can be packed. As used herein, the term “container” or “containers” encompasses cardboard boxes, bins, totes, cartons, bags, and any other vessel capable of storing inventory items. Also as used herein, the terms “substantially,” “generally,” “approximately” and “about” are intended to mean that slight deviations from absolute are included within the scope of the term so modified.

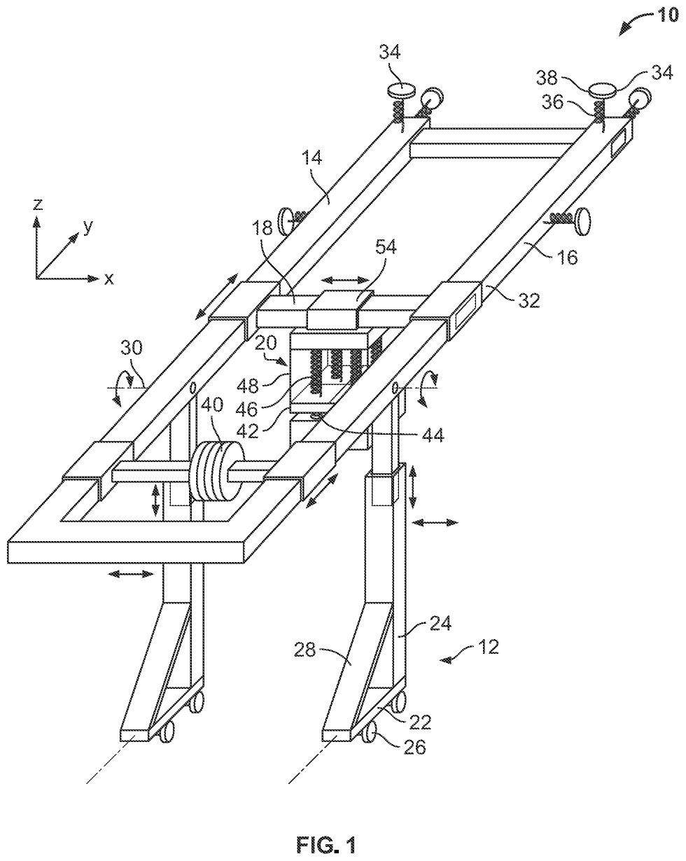

Referring to FIG. 1, gantry 10 includes a base 12, a first beam 14 and a second beam 16 supported by the base, a rail 18 moveable along the first and second beams, a trolley 54 moveable along the rail, and an extendable and retractable hoist 20 coupled to the trolley and arranged to secure one or more containers for loading the containers into a cargo area of a delivery vehicle and/or unloading the containers from the cargo area of the delivery vehicle. While the term “cargo area” is primarily described herein with reference to a semi-trailer, the term is inclusive of the cargo area of any motor vehicle such as box trucks, u-hauls, step vans, or buses; watercraft including boats, ferries, and ships; aircraft including but not limited planes; or any other vehicle capable of carrying cargo. Additionally, “cargo area” can refer to a staging area, within the warehouse, where containers are stacked on pallets, gaylords or large crates before the staging medium and all of the containers staged thereon are loaded into a delivery vehicle. In one embodiment, operation of gantry 10 is automated by one or more processors. The terms “automated” or “autonomous” mean gantry 10, or components thereof, operate without human assistance at least some of the time. Put differently, gantry 10, or components thereof, are “automated” or “autonomous” if operated with the assistance of a human at certain times so long as they are capable of being operated without human assistance at least some of the time. In other embodiments, operation of gantry 10 is always controlled by loading dock personnel, or remote personnel, via remote teleoperation, electronic signals, manually, or a combination of the foregoing.

The base 12 of gantry 10 is formed of feet 22 and legs 24. The feet 22 may include rollers 26, such as wheels, carriages or bearings, to move the entirety of gantry 10 relative to a ground surface. When the feet 22 include rollers 26, the gantry can be moved between docks at a warehouse, such that a single gantry 10 can be utilized to load and/or unload cargo from semi-trailers parked at different docks, thereby reducing operating costs. A locking mechanism can be provided on base 12, such as within feet 22, to prevent rollers 26 from unintentionally rolling during the loading and/or unloading of cargo. In another embodiment, gantry 10 does not include rollers. Instead, first beam 14 and second beam 16 may be fixed to a structure within the warehouse and arranged to extend and retract through a loading dock door to position the first and second beams within the semi-trailer.

Legs 24 may include an actuator designed to adjust the height of the legs and, in turn, the height of first beam 14 and the height of second beam 16. In this manner, gantry 10 can be utilized to load and/or unload cargo from delivery vehicles having cargo areas of different heights. Optional support members 28 may be added to base 12 between feet 22 and legs 24 to support larger payloads.

First beam 14 and second beam 16 may be connected to legs 24 at pivot axis 30 and oriented in a substantially parallel relationship to one another. Pivot axis 30 allows first beam 14 and second beam 16 to be rotated relative to base 12 to adjust the height of the leading end of the beams. Both first beam 14 and second beam 16 define a length (e.g., in the y-direction) and a width (e.g., in the x-direction) of gantry 10. The length of the first and second beams may be approximately 28 feet, 32 feet, 34 feet, 36 feet, 40 feet, 45 feet, 48 feet, 53 feet, or 57 feet (e.g., the standard lengths of North American semi-trailers) or any other length designed to span the entire length of a cargo area of a semi-trailer or the cargo area of another delivery vehicle. Similarly, first beam 14 and second beam 16 may be spaced apart in a width direction any distance designed to accommodate the standard width of a trailer, for example, 102 inches. Nevertheless, first beam 14 and second beam 16 can be manufactured to have other dimensions to accommodate the cargo areas of other vehicles having different widths.

Each of first beam 14 and second beam 16 define a track 32 upon which a respective carriage is mounted. Rail 18 is connected between the carriages such that the rail is moveable along the first and second beams to position hoist 20 at any location along the length of the semi-trailer. Rail 18 includes a position sensor such as an encoder and one or more actuators to drive movement of the rail along the tracks 32 in the y-direction. Example actuators include a linear actuator, a belt, a lead or ball screw and the like. In this regard, a processor can determine the location of rail 18 relative to track 32 and generate and transmit a processor executable control signal to automate the movement of the rail along the first and second beams.

Stabilizers 34 may be secured to the lateral or upper surfaces of first beam 14 and second beam 16 to stabilize gantry 10 against the inner sidewalls or the upper surface of the semi-trailer to prevent movement of the gantry relative to the semi-trailer during the loading or unloading of cargo. As shown in FIG. 1, stabilizers 34 may be formed of a compliant or biasing member 36 such as a spring and a support 38. In this manner, when first beam 14 and second beam 16 are moved within the semi-trailer, supports 38 engage an inner surface of the semi-trailer and compress biasing member 36, thereby creating a friction fit between the beams and the semi-trailer to stabilize gantry 10 relative to the semi-trailer. Stabilizers 34 may alternatively be formed as suction cups or any other resilient member designed to secure to the inner surfaces of the semi-trailer and stabilize gantry 10 relative to the semi-trailer via a suction force, a friction fit, or another force.

A weight 40 is coupled between first beam 14 and second beam 16. Weight 40 is designed to slide, or otherwise move, along the length of the beams. Movement of weight 40 in the y-directions will cause first beam 14 and second beam 16 to pivot about pivot axis 30. For example, moving weight 40 toward the leading end of the beams will cause the leading end of the beams to be lowered toward a ground surface. In contrast, moving weight 40 toward the trailing end of the beams will cause the leading end of the beams to be raised away from the ground surface. Thus, after first beam 14 and second beam 16 have been positioned within the interior of the semi-trailer, weight 40 can be moved toward the trailing end of the beams which will cause the leading end of the beams to pivot away from the ground surface and force stabilizers 34 into a forced engagement with an upper surface of the semi-trailer, thereby stabilizing gantry 10 within the semi-trailer. Instead of weight 40 being coupled between first the beams, weights may alternatively be applied directly to first beam 14 and/or second beam 16.

Hoist 20 is coupled underneath trolley 54, which is moveably mounted to rail 18 by any suitable connection (e.g., a mechanical or magnetic mechanism and the like) that allows the trolley to move in the width direction of gantry 10 (e.g., the x-direction). Hoist 20 includes a plate 42 provided with gripping device(s) arranged to secure a container. Plate 42 is suspended from trolley 54 by cables 48 which are connected to a winding mechanism such as a spool, reel or winch housed within or otherwise coupled to the trolley. Cables 48 can thus be wound and unwound, or spooled into and out from, trolley 54 to move plate 42 in the z-direction. An encoder may be coupled to the winding mechanism to measure the distance plate 42 moves in the z-direction. The winding mechanism may also include a torque sensor, limit switches or a load cell to detect the presence of a payload, tension in the cables or to measure the weight of a container supported by plate 42. Trolley 54 includes a position sensor and one or more actuators to automate movement of the trolley relative to rail 18 and hoist 20 includes one or more actuators to automate the extension and retraction of plate 42 and the actuation of the gripping device(s) provided on the plate. The combination of the movement of rail 18 along the beams in the y-direction and the movement of trolley 54 along the rail in the x-direction allows hoist 20 to be positioned over any area of the semi-trailer. Furthermore, the extension and retraction of plate 42 permits the plate to stack containers at any level (e.g., height) within the semi-trailer and then to subsequently pass over stacks of other containers. In one embodiment, trolley 54 defines a cavity in its underside to receive plate 42 when the plate is in its retracted position, thus preventing the plate from swinging when the hoist is moved laterally (in the x-y plane of the gantry).

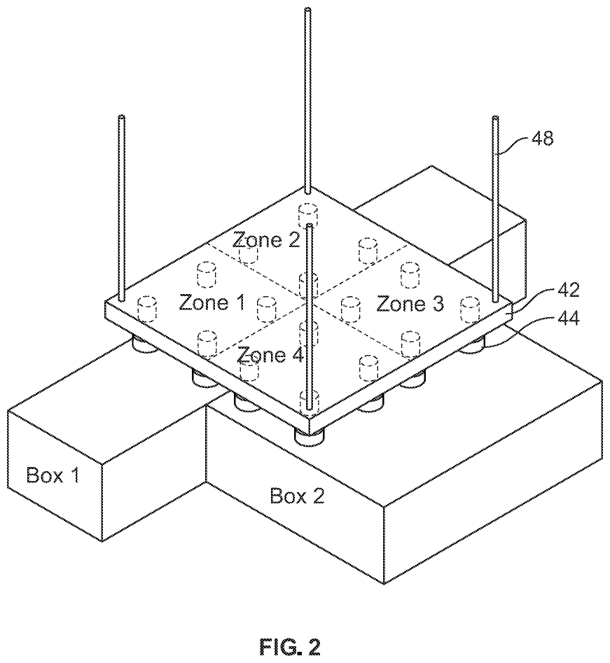

Plate 42 may optionally include one or more suctions cups 44 designed to secure the containers to hoist 20 via a suction force. When plate 42 includes suction cups 44, a pneumatic source (not shown), such as a vacuum source or a compressor, is provided to generate the pneumatic force necessary to operate the suction cups. If the pneumatic source is a compressor, a Venturi pump (not shown), or another device capable of using compressed air to produce a suction force, is positioned within a fluid line at a location downstream of the fluid source and upstream of suctions cups 44, for example, within trolley 54. The pneumatic fluid lines used to transmit pneumatics to suctions cups 44 may be air hose reels or coil hoses. In one embodiment, as best shown in FIG. 2, plate 42 can be divided into a plurality of zones, each of which encompass one or more suctions cups. The suctions cup(s) 44 in each zone may be in fluid communication with a separate section of fluid line 46 and isolated from the sections of fluid line in communication with other zones to allow the suction cup(s) 44 in each zone to be individually actuated. In this manner, the suctions cup(s) in multiple zones can be simultaneously actuated to securely grasp larger containers and individually actuated to selectively secure smaller containers to the suction cups located in one or more selected zones.

Plate 42 need not include suction cup(s) 44. Instead, plate 42 may instead include a pivoting flap, slidable or pivotable hooks, a latch, a grapple or another securement device (individually, along with suction cup(s) 44, “a gripping device”) capable of engaging an engagement feature located on the container such as a rib, aperture, loop, wall, hook or the like to secure the container to hoist 20. The gripping device may be actuated through a drive mechanism which may be powered and controlled by signals carried through cables 48, through a separate control cable (not shown), or wirelessly. A camera, or another imaging device, may be provided on hoist 20 to capture images of the cargo area which are transmitted to the one or more processors to assist in controlling the automation of gantry 10 including movement of rail 18 along the beams in the y-direction, movement of trolley 54 along the rail in the x-direction, the extension and retraction of the plate relative to the trolley (e.g., movement of the plate in the z-direction), and actuation of the gripping device to grasp and/or release the containers.

In some embodiments, hoist 20 is removably attached to trolley 54. In this manner, one hoist can be exchanged for a differently configured hoist depending upon the type of containers gantry 10 is tasked with loading or unloading. For example, a hoist including an array of suction cups may be exchanged (or “swapped”) for a hoist having different sized suction cups 44, a different array of suctions cups, or a plate equipped with another form of gripping device(s).

It is contemplated that the swapping of one hoist for another hoist may be manually performed by loading dock personnel (e.g., manually removing a first hoist from trolley 54 and connecting a second hoist to the trolley) or autonomously performed by gantry 10 upon the execution of a control signal. For example, in situations where hoist 20 is magnetically coupled to trolley 54 and gantry 10 receives and executes a processor executable control signal, the rail may move along tracks 32 toward the rear end of the first and second beams where various hoists may be stored in holders. With hoist 20 positioned over a holder, an electrical field surrounding trolley 54 may be terminated, thus, ending the magnetic connection and releasing the hoist into one of the holders. Subsequently, trolley 54 may then be positioned over a different hoist located in another holder before generating an electrical field to magnetically couple the trolley to that hoist. Similarly, when hoist 20 is coupled to trolley 54 via a mechanical connection, such as a push/pull connection, a twist-locked connection, or via gravity loading, the trolley may move in a manner (or have a separate component) that mechanically releases the hoist into a first holder and then connects with a different hoist located in another holder.

An example process of loading containers into a semi-trailer using gantry 10 will now be described. First, the base 12 of gantry 10 may be rolled, or otherwise moved, to position the base at an edge of the loading dock adjacent to the semi-trailer and to position first beam 14 and second beam 16 within the semi-trailer. Once in position, the locking mechanism may be actuated to prevent rollers 26 from unintentionally rolling to fix the base 12 of gantry 10 relative to the ground surface. Next, weight 40 may be moved toward the rear of the first and second beams to pivot the beams about pivot axis 30 until stabilizers 34 are forced into engagement with an inner-upper surface of the semi-trailer, thereby stabilizing the beams within the semi-trailer.

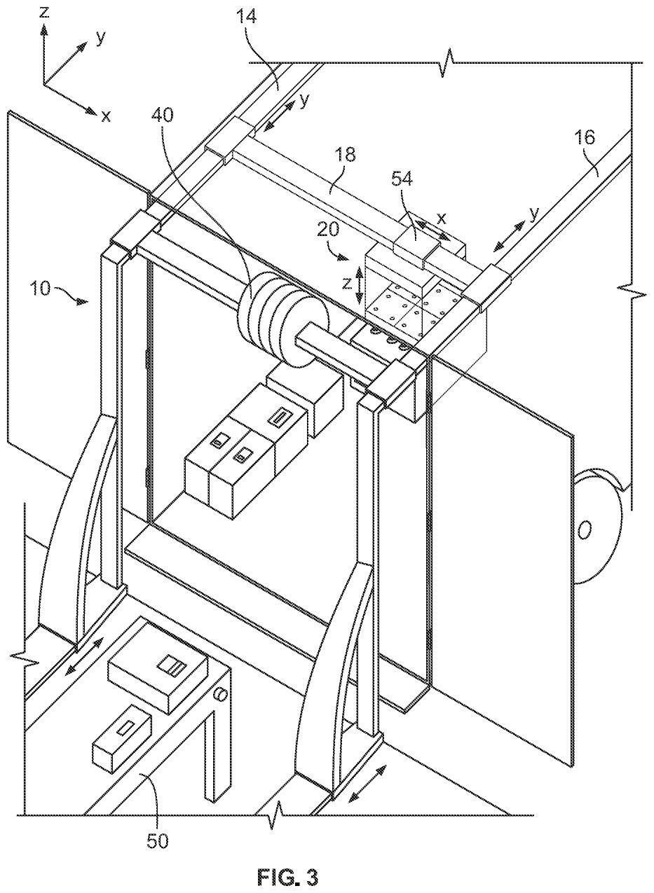

As shown in FIG. 3, a conveyer 50 for transporting containers from inside the warehouse to a location underneath gantry 10 may be assembled prior to, during, or after positioning and stabilizing the beams within the semi-trailer. Alternatively, gaylords or pallets may be used to position the containers underneath and within the reachable workspace of gantry 10. After the containers have been transported to a location underneath gantry 10, the plate 42 of hoist 20 may be extended to engage and secure one more containers as desired, for example, by actuating one or more zones of suction cups 44 as described above. With the container(s) secured to hoist 20, the plate 42 may then be retracted into the cavity of trolley 54 and moved to a location above a desired area of the semi-trailer by sliding rail 18 along the beams in a y-direction and by sliding the trolley along the rail in an x-direction. After hoist 20 has been positioned within an x-y plane, the plate 42 may be extended to its extended position before the container(s) are released on the semi-trailer floor or on top of another container.

The process of loading one or more containers at a time may be continued as the containers are loaded in levels. In other words, the containers may be loaded in one or more rows along the length of the vehicle and one or more rows along the width of the vehicle, with little to no space between adjacent rows, before the containers are stacked on top of earlier loaded containers. Loading the containers into the semi-trailer in this manner builds a stronger foundation for the subsequently loaded containers, improves packing density of the semi-trailer, and cases and expedites the stacking process. The foundation building process is made possible, in part, by the extendable and retractable plate 42 of hoist 20 which can pass over one or more stacks of containers to load another container. It will be appreciated that loading dock personnel who must walk along the storage bed of the semi-trailer cannot load a semi-trailer in this manner without stepping on or jumping over the earlier loaded containers. Similarly, known robotic systems have components that are prohibitively large and prevent the components from passing over stacks of a certain height thus necessitating that the containers be loaded into the trailer in vertical stacks from the front end to the backend of the trailer.

After each of the containers have been loaded into the semi-trailer, gantry 10 may be relocated to another dock for immediate use, stored inside the warehouse for future uses, or slid within the cargo area of the semi-trailer and transported along with the cargo to the destination location where the gantry can be utilized to unload the containers.

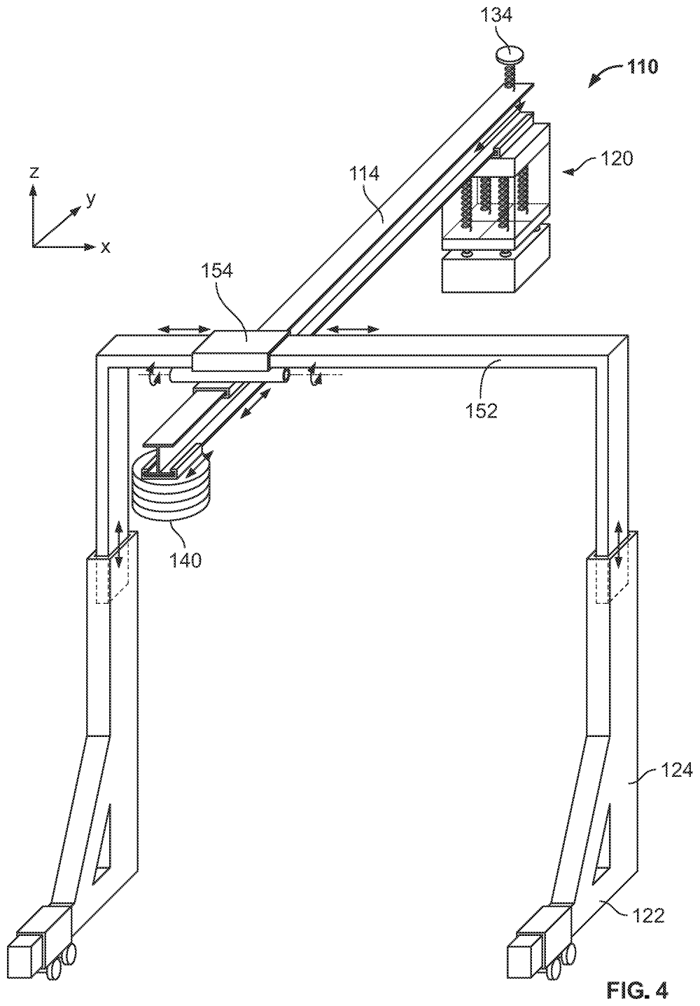

FIG. 4 illustrates a variant gantry 110 formed similar to gantry 10 but for the differences described below. The feet 122 and legs 124 of gantry 110 may be spaced apart a width that is wider than the widest width of a majority of semi-trailers. Gantry 110 includes a cross-rail 152 extending between legs 124. However, unlike rail 18 of gantry 10 which is moveable along first beam 14 and second beam 16, the cross-rail 152 of gantry 110 is fixed such that it is immoveable relative to legs 124. A trolley 154 couples a single beam 114 to the cross-rail. Trolley 154 is slidable along cross-rail 152 in the width direction (x-direction) which in turn moves the single beam in the x-direction. Hoist 120 is mounted to a carriage that is slidable along the length of single beam 114. Because trolley 154 is slidable along cross-rail 152, which is wider than the width of various cargo areas, gantry 110 can be utilized to load and/or unload containers from cargo areas having a relatively wide width and cargo areas having a relatively narrow width.

Use of variant gantry 110 is similar to the use of gantry 10 aside from the fact that the containers are preferably loaded into the semi-trailer in a series of horizontal rows along the length direction (y-direction) of the cargo area. This avoids the need to constantly move weight 140 toward and away from the leading end of single beam 114 to disengage and engage stabilizers 134 against a surface of the semi-trailer before moving trolley 154 along cross-rail 152 to reposition single beam 114. Each time trolley 154 is repositioned in the x-direction, the hoist 120 may then load/unload a subsequent row of containers in the y-direction. This process can be repeated as the containers are loaded in levels.

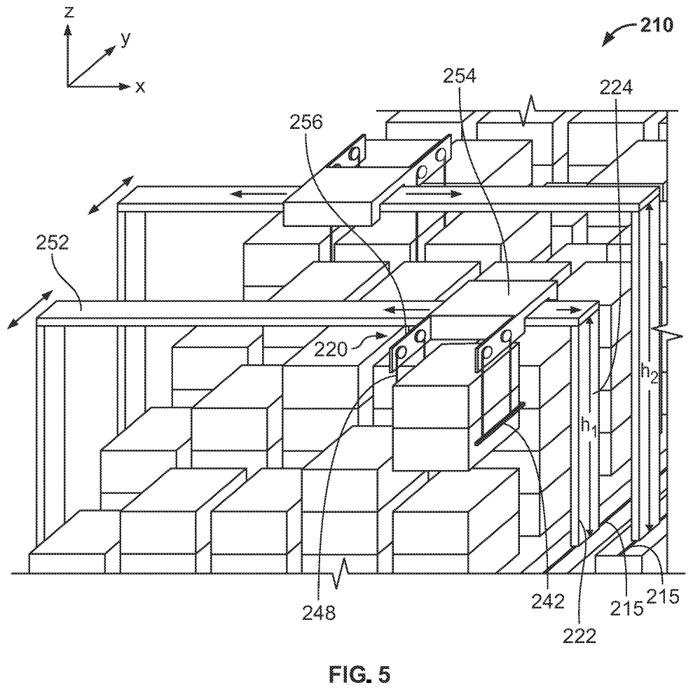

FIG. 5 illustrates another variant gantry 210 for storing, retrieving, handling and stacking containers and may be used, for example, at a fulfillment center to temporarily stack and store containers within a warehouse, or to palletize containers for future transportation. Gantry 210 includes legs 224 provided with rollers or bearings, which allow gantry 210 to slide along a track 215 in the y-direction. Cross-rail 252 extends between legs 224 and serves as a track for trolley 254 to move along the cross-rail in the x-direction. Trolley 254 supports hoist 220. In one embodiment, hoist 220 may be provided underneath trolley 254 and be formed substantially similar to hoist 20 and hoist 120. Alternatively, hoist 220 may include arms 256 that extend laterally away from trolley 254 and that support plate 242 via cables 248. Plate 242 includes at least three sides defining a central aperture sized and configured to surround a stack of containers when the plate is lowered in the z-direction before the gripping device is actuated to grab an engagement feature on a container. Hoist 220 is thus arranged relocate multiple containers in a single lift (e.g., the container secured to plate 242 and each of the containers stacked on top of the secured container).

As shown in FIG. 5, a container handling area may have more than one gantry 210. The gantries 210 may be independently moveable along a single track 215 or a series of tracks. In one embodiment, the cross-rails 252 of multiple gantries 210 may be formed at different heights (h1, h2) to allow the gantries to move past one another by sliding underneath or above another gantry.

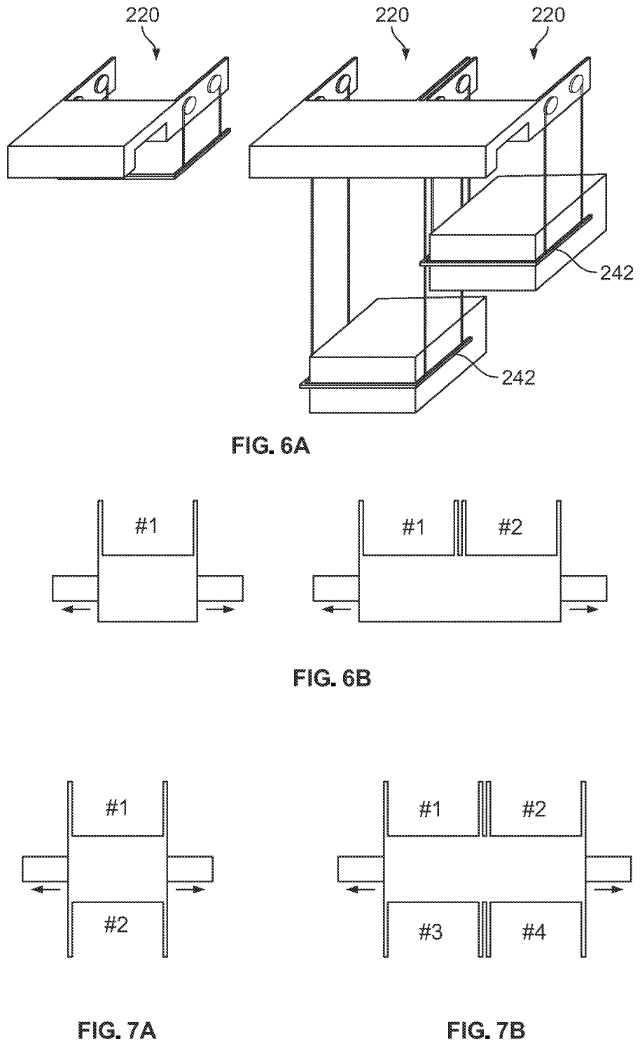

With additional reference to FIGS. 6 and 7, a single trolley 254 may carry a single hoist 220, two hoists in a side-by-side relationship, two hoists in an opposing relationship, or four hoists, to increase efficiency. It will be appreciated that these configurations are merely exemplary and trolley 254 may carry any number of hoists, such as three hoists or more than four hoists, and may do so in any configuration. In use, the automated movement of legs 224 along tracks 215 in the y-direction and the automated movement of trolley 254 along cross-rail 252 in the x-direction, allows hoist 220 to be positioned over any area of the workspace as the plate(s) 242 are used to stack and store, or palletize, containers into stacks.

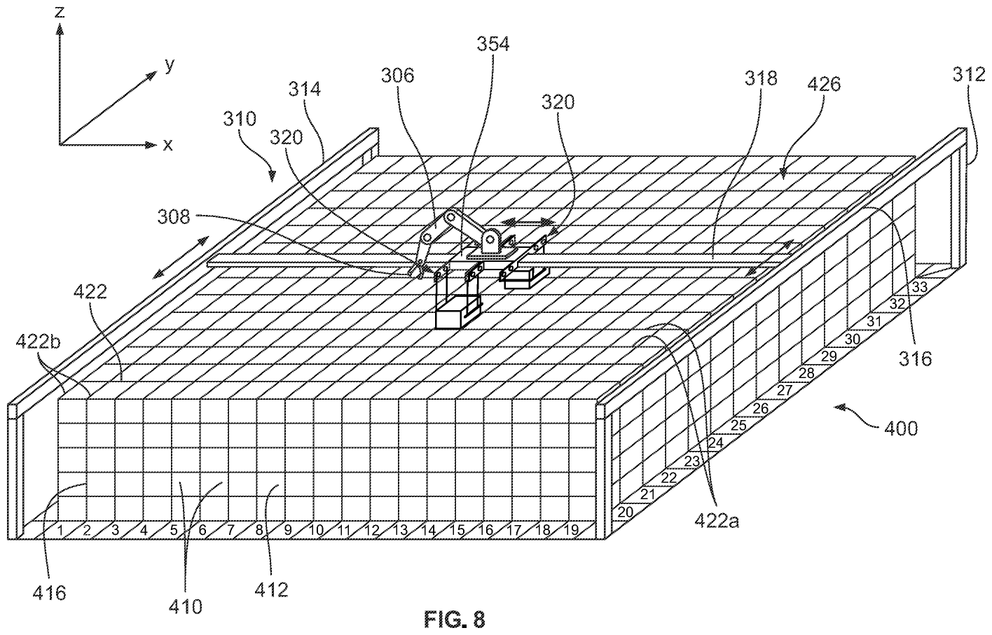

FIG. 8 illustrates yet another variant gantry 310 for picking and packing orders in micro-fulfilment centers and may be used, for example, in combination with grid-based storage systems such as that disclosed in U.S. Pat. Pub. No. 2021/0032034, which is incorporated herein in its entirety.

Storage structure 400 is arranged to efficiently store a plurality of stackable containers 410 holding a plurality of product items (not shown) of identical or different product types. Containers 410 are designed to nest within an upper surface (i.e., rim) of another container to form stacks 412 that can be housed in a frame 414 of storage structure 400.

Frame 414 includes pillars 416 and a series of tracks 422 arranged in a grid-like pattern at an uppermost level of the frame. For this reason, tracks 422 are collectively referred to as a grid 426 having a plurality of “grid spaces.” Pillars 416 form shafts within which stacks 412 are housed. As a result, each stack 412 is located within the footprint of a respective grid space (e.g., longitudinally underneath the respective grid space). The cross-sectional area of each shaft is slightly larger than the outer dimensions of containers 410 such that a small gap of space exists between the outer surface of the containers and pillars 416.

Each track 422 may be extruded from a metal or metal alloy to form a drive surface for robots (not shown) to move about grid 426 while fulfilling orders. A first set of parallel tracks 422a guides movement of the robots in a first direction (e.g., the X-direction), and a second set of parallel tracks 422b, arranged perpendicular to the first set of parallel tracks, guides movement of the robots in a second direction (e.g., the Y-direction). In this manner, tracks 422 allow the robot to move laterally in two directions (in the X-direction and in the Y-direction) across the top of frame 414 such that the robots can be moved into position above any one of the stacks 412 of containers 410 to pick and pack items.

Gantry 310 includes a base 312, a first beam 314 and a second beam 316 supported by the base, a rail 318 moveable along the first and second beams, a trolley 354 moveable along the rail, one or more extendable and retractable hoists 320 coupled to the trolley and arranged to handle one or more containers 410, and optionally, a picking arm 306 having an end effector 308 for manipulating items stored within the containers. Base 312 may be formed at least one “grid-space” larger than frame 414 thus allowing containers to be lifted in and out of storage structure 400, by gantry 310, at any location adjacent the storage structure. In this regard, storage structure 400 need not include designated in/out modules, which allows more containers to enter and/or exit the storage structure at a given time, thereby increasing order fulfilment throughput. In some embodiments, first beam 314 and second beam 316 may be elevated to a height above grid 426 that allows the rail 318 to pass over robots operating on the grid. Nevertheless, because gantry 310 is designed to perform the same function of the robots, the system need not include robots operating on grid 426. In situations where robots are not installed on grid 426, the first and second beams only need to be elevated slightly above the grid. Furthermore, when the system does not include robots, it will be understood that storage structure 400 does not need to be formed of tracks configured to support robots. Instead, containers may be free-standing (e.g., without a storage structure), housed within a storage structure formed solely of pillars 416, or housed within a storage structure formed of pillars 416 and cross-connections, which need not be formed as a drive surface for robots.

Rail 318 may be structurally and functionally similar to rail 18 in that rail 318 is autonomously moveable along first beam 314 and second beam 316 in a first direction, such as the y-direction. Likewise, trolley 354 may be structurally and functionally similar to trolley 54 in that trolley 354 is moveable along rail 318 in a second direction perpendicular to the first direction, for example, the x-direction. Trolley 354 supports one or more hoists 320, for example, any of the hoist configurations described with respect to FIGS. 6A-7B.

As shown in FIG. 8, trolley 354 may support four hoists 320. Similar to hoist 220, each hoist 320 includes support arms 356 and a grapple designed to extract storage containers from frame 414 and/or to secure order containers. The grapple is suspended from support arms 356 by cables which are connected to a winding mechanism such as a spool, hoist, or winch. The cables can thus be wound and unwound to adjust the height of the grapple with respect to the support arms in the z-direction.

In one embodiment, the grapple includes a three-sided grapple plate and pivotable flaps. The three sides of the grapple plate are formed by opposing grapple arms and a connector. The grapple arms and the connector collectively define an aperture. Each flap is pivotable relative to a respective grapple arm between a deployed configuration in which the flap extends away from the grapple arm and into the aperture and an undeployed configuration in which the flap lies substantially flush against the grapple arm. Movement of the flaps between the undeployed and deployed configurations may be controlled by an actuator disposed within the grapple and configured to convert an electrical signal carried through the cables to rotational motion of the flaps. When the flaps are in the undeployed configuration, the aperture is larger than containers, allowing the grapple to be lowered into the gap, between the containers and pillars 416, and around a stack 412 of containers 410, before the flaps are deployed and brought into engagement with an engagement feature such as a rib (not shown) on a side of the container. In this manner, hoist 320 is arranged to extract the container secured to the grapple plate and any of the containers stacked on top of the secured container in a single lift.

Gantry 310 may optionally include a picking arm 306 equipped with an end effector 308 for picking and packing inventory items. Picking arm 306 is moveable in at least three dimensions to allow end effector 308 to pick an inventory item from a storage container (e.g., containers storing inventory items) and pack the picked inventory items into an order container. End effector 308 may be a pneumatically actuated end effector such as a suction cup.

Use of gantry 310 to pick and pack inventory items within a warehouse will now be described. Upon receiving instructions to pick and pack an item into an order container secured to hoist 320, rail 318 may be moved along the first and second beams in the y-direction while trolley 354 is moved along rail 318 in the x-direction to a location above a desired grid space. For example, if the desired item is housed in a storage container located at the top of a stack 412, trolley 354 may be positioned above a grid space proximate to the grid space above which the item is located. Once in position, end effector 308 may be positioned within the storage container and end effector 308 may be used to grasp the item. After the item has been grasped, picking arm 306 may be moved toward the order the container to pack the item.

On the other hand, if the desired item is located in a stack underneath other containers, the container housing the desired item (e.g., the “target container”) must first be extracted. To extract the target container, gantry 310 may be moved, as explained above, to position one of the hoists 320 (not carrying the order container) over the stack 412 housing the target container. The grapple plate may then be lowered into the gap, and around stack 412, until the grapple plate is positioned around the container nested within the target container. With the grapple in position, the flaps may be deployed and brought into engagement with a rib, or another engagement feature, on a side of the container to secure the container to the grapple. With container 410 secured to the grapple plate, the winding mechanism may be wound to retract the grapple plate and to lift the container and any containers stacked on top of that container. Trolley 354 may then be moved one grid space and another hoist 320 may then be used to extract the target container. With the extracted target container secured to the grapple plate, picking arm 106 may pick the item from the target container and pack the picked item into the order container. The hoists may then deposit the containers 410 back into the stack 412 in their original order.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A gantry, comprising:
a pair of substantially parallel beams in a first direction;
a rail mounted between the beams and being moveable along the beams; and
a trolley coupled to and moveable along the rail in a second direction perpendicular to the first direction, the trolley supporting a hoist including a plate having an actuatable gripping device for selectively engaging and releasing the containers, the plate being moveable in a vertical direction relative to the trolley between a retracted position and an extended position to lift and lower the containers.

2. The gantry of claim 1, further comprising one or more processors configured to control movement of the rail in the first direction, movement of the trolley in the second direction, movement of the plate between the retracted position and the extended position, and/or actuation of the gripping device.

3. The gantry of claim 2, further comprising a position sensor provided on at least one of the rail, the trolley or the hoist.

4. The gantry of claim 1, further comprising a base supporting the beams, the base including adjustable support legs arranged to adjust a height of the beams relative to a ground surface.

5. The gantry of claim 1, wherein at least one of the beams further comprises a stabilizer.

6. The gantry of claim 5, wherein the beams are connected to a base at a pivot axis such that the beams are rotatable about the pivot axis to adjust a height of a leading end of the beams and, in turn, engage the stabilizer against a ceiling of the cargo area or disengage the stabilizer from the ceiling of the cargo area.

7. The gantry of claim 6, further comprising weight coupled to the beams, the weight being moveable along a length of the beams to rotate the beams about the pivot axis.

8. The gantry of claim 5, wherein the stabilizer comprises a compliant bumper.

9. The gantry of claim 1, wherein the trolley or the hoist comprises an imaging device.

10. The gantry of claim 1, wherein the gripping device comprises at least one suction cup.

11. The gantry of claim 10, further comprising at least one fluid line in fluid communication with the at least one suction cup.

12. The gantry of claim 11, wherein the at least one suction cup comprises a first suction cup and a second suction cup, and the at least one fluid line comprises a first fluid line section in communication with the first suction cup and isolated from the second suction cup and a second fluid line section in communication with the second suction cup and isolated from the first suction cup.

13. The gantry of claim 1, wherein the gripping device is a mechanical gripping device comprising slidable or pivotable hooks, a latch, a grapple, and/or a pivotable flap.

14. The gantry of claim 1, wherein an underside of the trolley defines a cavity to receive the plate when the plate is in the retracted position.

15. The gantry of claim 1, wherein the gantry is arranged to be entirely spaced away from a bed of a cargo area.

16. (canceled)

17. An automated gantry, comprising:
a base including a pair of support legs and a cross-rail extending between the pair of support legs, the base being moveable in a first horizontal direction;
a trolley moveable along the cross-rail in a second horizontal direction perpendicular to the first horizontal direction; and
a hoist coupled to the trolley, the hoist including a plate having a gripping device for selectively engaging and releasing containers, the plate being moveable in a vertical direction relative to the trolley between a retracted position and an extended position to lift and lower the containers.

18. The automated gantry of claim 17, wherein the hoist comprises arms extending laterally away from the trolley, and wherein the plate is suspended from the arms by cables.

19. An automated gantry, comprising:
first and second beams elevated above a ground surface and extending in a first horizontal direction;
a rail extending between first and second carriages movably mounted to the first and second beams, respectively, such that the rail is moveable along the first and second beams in the first horizontal direction;
a trolley coupled to and moveable along the rail in a second horizontal direction perpendicular to the first direction; and
at least one hoist coupled to the trolley, the at least one hoist including a plate having an actuatable gripping device for selectively engaging and releasing the containers, the plate being moveable in a vertical direction relative to the trolley between a retracted position and an extended position to lift and lower the containers.

20. The automated gantry of claim 19, wherein the at least one hoist is a plurality of hoists.

21. The automated gantry of claim 19, further comprising a picking arm coupled the trolley and arranged to pick items from containers located underneath the rail.
